(19) United States
(12) Patent Application Publication
(10) Pub. No.: US 2016/0057396 A1
(43) Pub. Date: Feb. 25, 2016

(54) IMAGE DEVICE WITH IMPROVED CHROMINANCE QUALITY

(71) Applicant: VP ASSETS LIMITED, Shatin N.T. Hong Kong (CN)

(72) Inventors: Gia Chuong Phan, Hong Kong (CN); Maggie Phan, Hong Kong (CN); Anthony Phan, Hong Kong (CN)

(73) Assignee: VP ASSETS LIMITED, Shatin N.T. Hong Kong (CN)

(21) Appl. No.: 14/517,670

(22) Filed: Oct. 17, 2014

Related U.S. Application Data
(63) Continuation-in-part of application No. 14/465,496, filed on Aug. 21, 2014.

(51) Int. Cl. H04N 9/07

(52) U.S. Cl. CPC H04N 9/07

(57) ABSTRACT

The invention provides an image device with improved chrominance quality. The image device includes a plurality of RGBW pixels and a plurality of RGBY pixels. Each RGBW pixel includes a red sub-pixel, a green sub-pixel, a blue sub-pixel and a white sub-pixel. Each RGBY pixel includes a red sub-pixel, a green sub-pixel, a blue sub-pixel and a yellow sub-pixel. In a RGBW pixel, the blue sub-pixel has an area about the same as that of the other sub-pixels in the same RGBW pixel. In a RGBY pixel, the blue sub-pixel has an area larger than that of the other sub-pixels in the same RGBY pixel. The RGBW pixels and RGBY pixels are mixed in the image device. Therefore, a white balance status can be achieved within one RGBY pixel, and thus the chrominance quality of the display can be improved.

This application is a Continuation-in-Part of co-pending application Ser. No. 14/465,496 filed on Aug. 21, 2014. The entire contents of the above application are hereby incorporated by reference.

### BACKGROUND OF THE INVENTION

1. Field of the Invention

The invention relates to an image device with improved chrominance quality by the utilization of RGBW pixels and RGBY pixels.

2. Description of the Related Art

Referring to FIG. 6, it shows a conventional RGBW display. The conventional RGBW display 10 includes a plurality of RGBW pixels 11. Each RGBW pixel 11 includes a green sub-pixel 111, a red sub-pixel 112, a blue sub-pixel 113 and a white sub-pixel 114 arranged in a 2×2 matrix. The conventional RGBW display 10 has the merit of enhanced color space and improved brightness and contrast, compared with traditional RGB display. U.S. Pat. No. 4,892,391, U.S. Pat. No. 5,757,452, U.S. Pat. Nos. 7,286,136, 7,742,205, and U.S. Pat. No. 7,583,279 teach RGBW displays. However, the conventional RGBW display 10 has the deficiency of dark yellow. U.S. Pat. No. 4,800,375, U.S. Pat. No. 7,864,271, and U.S. Pat. No. 8,749,727 teach RGBY displays which claim to have better yellow color. However, RGBY display lacks the merits of RGBW displays. U.S. Pat. No. 7,248,314, U.S. Pat. No. 7,995,019, U.S. Pat. No. 8,248,440, U.S. Pat. No. 8,441,601 and U.S. Pat. No. 8,558,857 teach displays with pixels of five color sub-pixels. However five color pixel displays have the deficiency of high display manufacturing complexity and cost. Moreover, the color conversion from RGB to five color pixels is also more difficult.

### SUMMARY OF THE INVENTION

The present invention provides an image device. The image device includes a plurality of RGBW pixels and a plurality of RGBY pixels. Each RGBW pixel includes a red sub-pixel, a green sub-pixel, a blue sub-pixel and a white sub-pixel. Each RGBY pixel includes a red sub-pixel, a green sub-pixel, a blue sub-pixel and a yellow sub-pixel. In a RGBW pixel the blue sub-pixel has an area about the same as that of the other sub-pixels in the same RGBW pixel. In a RGBY pixel the blue sub-pixel has an area larger than that of the other sub-pixels in the same RGBY pixel. The RGBW pixels and RGBY pixels are mixed in the image device.

The present invention also provides a method to determine the ratio of the number of RGBW pixels to the number of RGBY pixels in an image device. The method includes a step for determining the ratio by a function of a yellow sub-pixel information, a red sub-pixel information, a green sub-pixel information, a blue sub-pixel information and a white sub-pixel information of the image device.

The present invention also provides a method to determine the ratio of the number of RGBW pixels to the number of RGBY pixels in an image device. The method includes a step for determining the ratio by a function of a yellow sub-pixel information and a white sub-pixel information of the image device.

In the present invention, the blue sub-pixel has a larger area than the other sub-pixels in each RGBY pixel. Therefore a white balance status can be achieved within one RGBY pixel and thus the chrominance quality of the display can be improved. In some of the embodiments of the present invention, any four adjacent sub-pixel arranged in a 2×2 matrix can produce a white color. These embodiments have the further advantages of eliminating color fringe problem. For example alternating back and white lines can be displayed without color fringe. Another example is that fonts can be displayed without color fringe.

### BRIEF DESCRIPTION OF THE DRAWING

Further advantageous measures are described in the dependent claims. The invention is shown in the attached drawing and is described hereinafter in greater detail.

FIG. 1A shows an image device according to an embodiment of the invention;

FIG. 1B shows an image device according to an embodiment of the invention;

FIG. 1C shows an image device according to an embodiment of the invention;

FIG. 1D shows an image device according to an embodiment of the invention;

FIG. 2A shows an image device according to an embodiment of the invention;

FIG. 2B shows an image device according to an embodiment of the invention;

FIG. 2C shows an image device according to an embodiment of the invention;

FIG. 2D shows an image device according to an embodiment of the invention;

FIG. 3A shows an image device according to an embodiment of the invention;

FIG. 3B shows an image device according to an embodiment of the invention;

FIG. 3C shows an image device according to an embodiment of the invention;

FIG. 3D shows an image device according to an embodiment of the invention;

FIG. 4A shows an image device according to an embodiment of the invention;

FIG. 4B shows an image device according to an embodiment of the invention;

FIG. 4C shows an image device according to an embodiment of the invention;

FIG. 4D shows an image device according to an embodiment of the invention;

FIG. 5A shows an image device according to an embodiment of the invention;

FIG. 5B shows an image device according to an embodiment of the invention;

FIG. 5C shows an image device according to an embodiment of the invention;

FIG. 5D shows an image device according to an embodiment of the invention; and

FIG. 6 shows a conventional RGBW display.

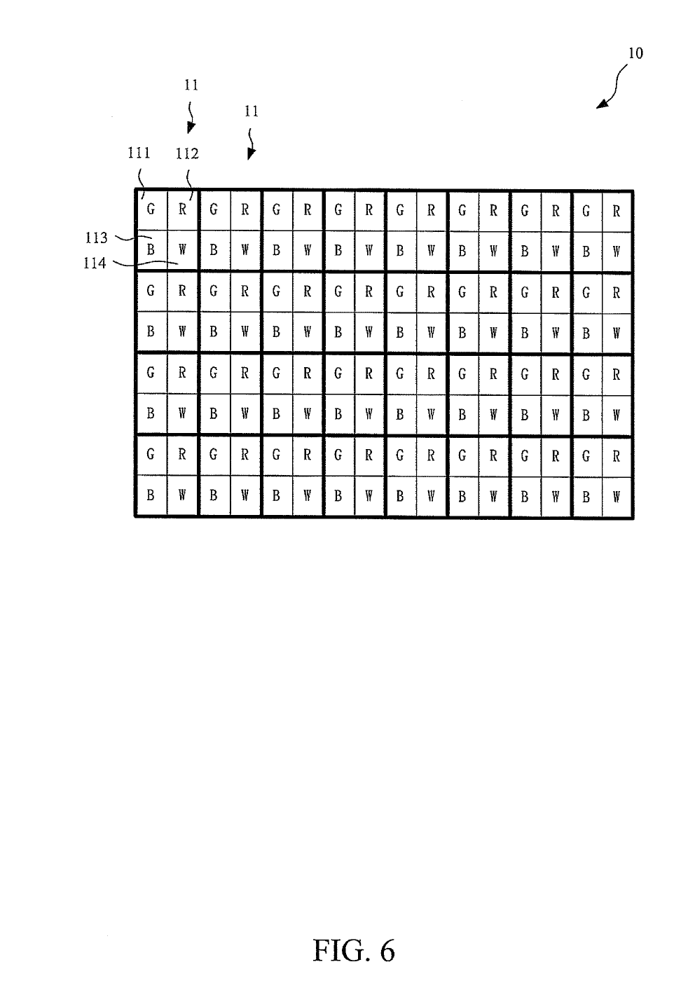

### DETAILED DESCRIPTION OF THE INVENTION

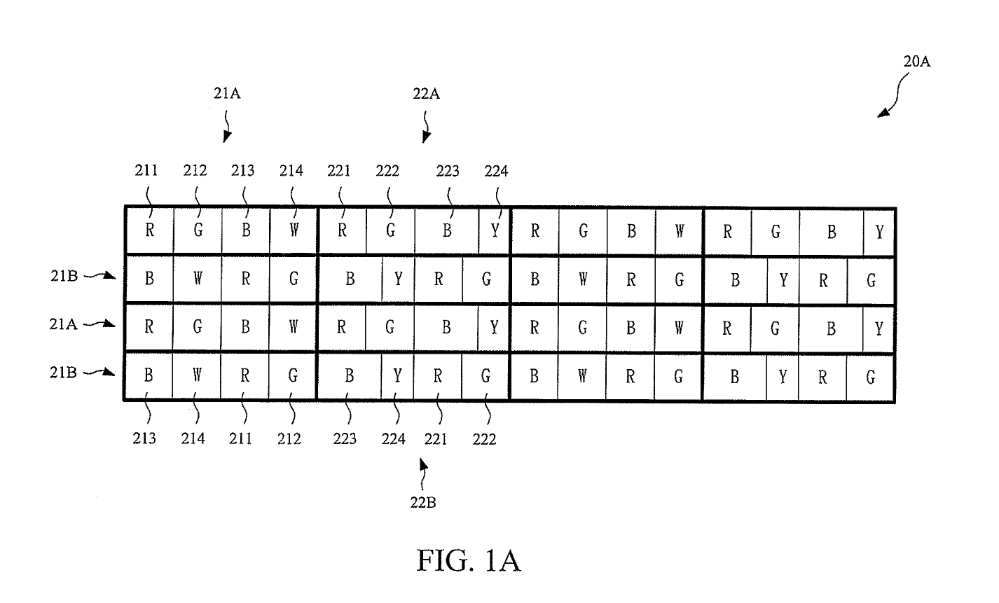

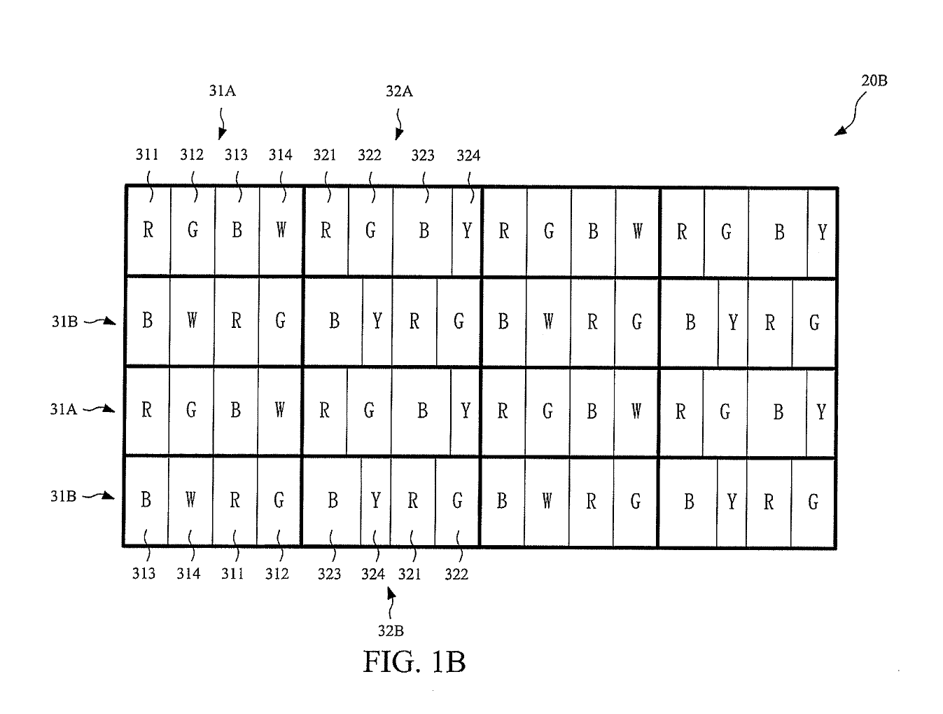

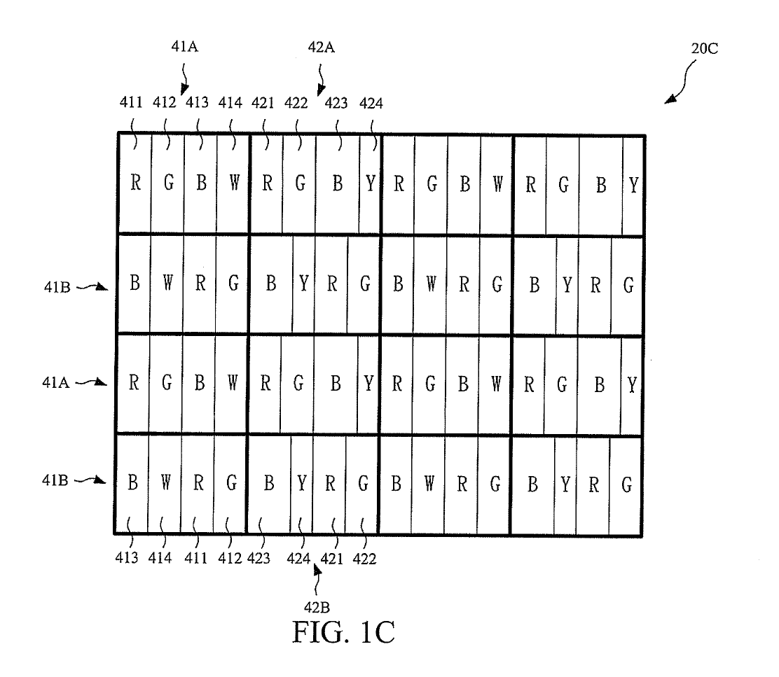

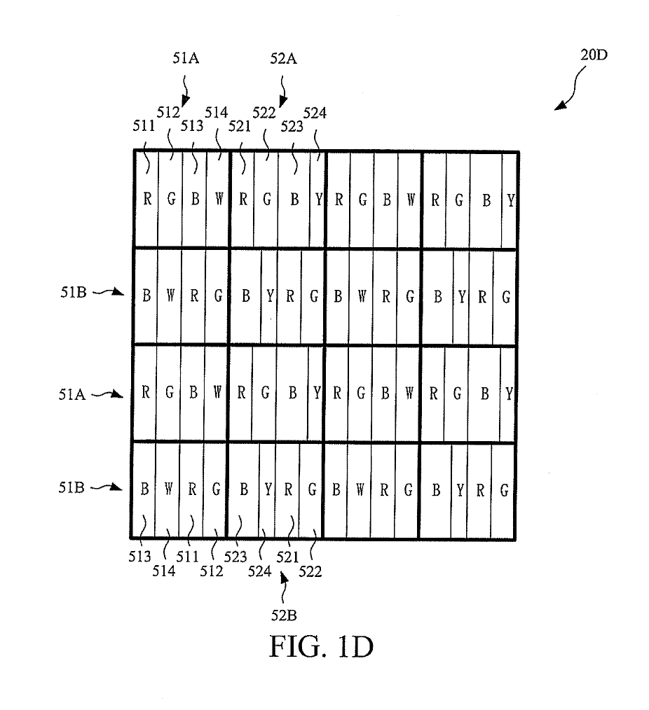

Referring to FIG. 1A, it shows an image device according to an embodiment of the invention. The image device 20A includes a plurality of RGBW pixels 21A, 21B and a plurality of RGBY pixels 22A, 22B. The RGBW pixels 21A, 21B and the RGBY pixels 22A, 22B are mixed in the image device 20A. Each RGBW pixel includes a red sub-pixel, a green sub-pixel, a blue sub-pixel and a white sub-pixel. The RGBW pixel 21A includes a red sub-pixel 211, a green sub-pixel 212, a blue sub-pixel 213 and a white sub-pixel 214, and the RGBW pixel 21B includes a red sub-pixel 211, a green sub-pixel 212, a blue sub-pixel 213 and a white sub-pixel 214. In an embodiment, the red sub-pixel 211, the green sub-pixel 212, the blue sub-pixel 213 and the white sub-pixel 214 are arranged in a 1×4 matrix. In the RGBW pixel 21A, the sequence of the sub-pixels in the 1×4 matrix from left to right is the red sub-pixel 211, the green sub-pixel 212, the blue sub-pixel 213 and the white sub-pixel 214. In the RGBW pixel 21B, the sequence of the sub-pixels in the 1×4 matrix from left to right is the blue sub-pixel 213, the white sub-pixel 214, the red sub-pixel 211 and the green sub-pixel 212. Each sub-pixel is formed as about a square shape. In the RGBW pixel, the blue sub-pixel has an area about the same as that of the other sub-pixels in the same RGBW pixel.

Each RGBY pixel includes a red sub-pixel, a green sub-pixel, a blue sub-pixel and a yellow sub-pixel. The RGBY pixel 22A includes a red sub-pixel 221, a green sub-pixel 222, a blue sub-pixel 223 and a yellow sub-pixel 224, and the RGBY pixel 22B includes a red sub-pixel 221, a green sub-pixel 222, a blue sub-pixel 223 and a yellow sub-pixel 224. In an embodiment, the red sub-pixel 221, the green sub-pixel 222, the blue sub-pixel 223 and the yellow sub-pixel 224 are arranged in a 1×4 matrix. In the RGBY pixel 22A, the sequence of the sub-pixels in the 1×4 matrix from left to right is the red sub-pixel 221, the green sub-pixel 222, the blue sub-pixel 223 and the yellow sub-pixel 224. In the RGBY pixel 22B, the sequence of the sub-pixels in the 1×4 matrix from left to right is the blue sub-pixel 223, the yellow sub-pixel 224, the red sub-pixel 221 and the green sub-pixel 222.

In the RGBY pixel, the blue sub-pixel has an area larger than that of the other sub-pixels in the same RGBY pixel. That is, the area of the blue sub-pixel 223 is larger than that of the red sub-pixel 221, the area of the blue sub-pixel 223 is larger than that of the green sub-pixel 222, and the area of the blue sub-pixel 223 is larger than that of the yellow sub-pixel 224. In the RGBY pixel, the yellow sub-pixel has an area smaller than that of the other sub-pixels in the same RGBY pixel. That is, the area of the yellow sub-pixel 224 is smaller than that of the red sub-pixel 221, the area of the yellow sub-pixel 224 is smaller than that of the green sub-pixel 222, and the area of the yellow sub-pixel 224 is larger than that of the blue sub-pixel 223. In an embodiment, the yellow sub-pixel 224 has an area about half of that of the blue sub-pixels 223 in the same RGBY pixel. In other embodiment, the yellow sub-pixel has an area about one-third of that of the blue sub-pixels in the same RGBY pixel.

In the image device 20A, the ratio of the number of RGBW pixels to the number of RGBY pixels is about 1:1. In the image device 20A, the blue sub-pixel has a larger area than the other sub-pixels in each RGBY pixel. Therefore a white balance status can be achieved within one RGBY pixel and thus the chrominance quality of the display can be improved.

Referring to FIG. 1B, it shows an image device according to an embodiment of the invention. The image device 20B includes a plurality of RGBW pixels 31A, 31B and a plurality of RGBY pixels 32A, 32B. The RGBW pixels 31A, 31B and the RGBY pixels 32A, 32B are mixed in the image device 20B. Each RGBW pixel includes a red sub-pixel, a green sub-pixel, a blue sub-pixel and a white sub-pixel. The RGBW pixel 31A includes a red sub-pixel 311, a green sub-pixel 312, a blue sub-pixel 313 and a white sub-pixel 314, and the RGBW pixel 31B includes a red sub-pixel 311, a green sub-pixel 312, a blue sub-pixel 313 and a white sub-pixel 314. In an embodiment, the red sub-pixel 311, the green sub-pixel 312, the blue sub-pixel 313 and the white sub-pixel 314 are arranged in a 1×4 matrix. In the RGBW pixel 31A, the sequence of the sub-pixels in the 1×4 matrix from left to right is the red sub-pixel 311, the green sub-pixel 312, the blue sub-pixel 313 and the white sub-pixel 314. In the RGBW pixel 31B, the sequence of the sub-pixels in the 1×4 matrix from left to right is the blue sub-pixel 313, the white sub-pixel 314, the red sub-pixel 311 and the green sub-pixel 312. Each sub-pixel is formed as about a rectangular shape. Any two adjacent sub-pixels along a longer border are formed as about a square shape. That is, two adjacent sub-pixels, for example the red sub-pixel 311 and the green sub-pixel 312, along a longer border are formed as about a square shape. In the RGBW pixel, the blue sub-pixel has an area about the same as that of the other sub-pixels in the same RGBW pixel.

Each RGBY pixel includes a red sub-pixel, a green sub-pixel, a blue sub-pixel and a yellow sub-pixel. The RGBY pixel 32A includes a red sub-pixel 321, a green sub-pixel 322, a blue sub-pixel 323 and a yellow sub-pixel 324, and the RGBY pixel 32B includes a red sub-pixel 321, a green sub-pixel 322, a blue sub-pixel 323 and a yellow sub-pixel 324. In an embodiment, the red sub-pixel 321, the green sub-pixel 322, the blue sub-pixel 323 and the yellow sub-pixel 324 are arranged in a 1×4 matrix. In the RGBY pixel 32A, the sequence of the sub-pixels in the 1×4 matrix from left to right is the red sub-pixel 321, the green sub-pixel 322, the blue sub-pixel 323 and the yellow sub-pixel 324. In the RGBY pixel 22B, the sequence of the sub-pixels in the 1×4 matrix from left to right is the blue sub-pixel 323, the yellow sub-pixel 324, the red sub-pixel 321 and the green sub-pixel 322.

In the RGBY pixel, the blue sub-pixel has an area larger than that of the other sub-pixels in the same RGBY pixel. That is, the area of the blue sub-pixel 323 is larger than that of the red sub-pixel 321, the area of the blue sub-pixel 323 is larger than that of the green sub-pixel 322, and the area of the blue sub-pixel 323 is larger than that of the yellow sub-pixel 324. In the RGBY pixel, the yellow sub-pixel has an area smaller than that of the other sub-pixels in the same RGBY pixel. That is, the area of the yellow sub-pixel 324 is smaller than that of the red sub-pixel 321, the area of the yellow sub-pixel 324 is smaller than that of the green sub-pixel 322, and the area of the yellow sub-pixel 324 is larger than that of the blue sub-pixel 323. In an embodiment, the yellow sub-pixel 324 has an area about half of that of the blue sub-pixels 323 in the same RGBY pixel. In other embodiment, the yellow sub-pixel has an area about one-third of that of the blue sub-pixels in the same RGBY pixel.

In the image device 20B, the ratio of the number of RGBW pixels to the number of RGBY pixels is about 1:1. In the image device 20B, the blue sub-pixel has a larger area than the other sub-pixels in each RGBY pixel. Therefore a white balance status can be achieved within one RGBY pixel and thus the chrominance quality of the display can be improved.

Referring to FIG. 1C, it shows an image device according to an embodiment of the invention. The image device 20C includes a plurality of RGBW pixels 41A, 41B and a plurality of RGBY pixels 42A, 42B. The RGBW pixels 41A, 41B and the RGBY pixels 42A, 42B are mixed in the image device 20C. Each RGBW pixel includes a red sub-pixel, a green sub-pixel, a blue sub-pixel and a white sub-pixel. The RGBW pixel 41A includes a red sub-pixel 411, a green sub-pixel 412, a blue sub-pixel 413 and a white sub-pixel 414, and the RGBW pixel 41B includes a red sub-pixel 411, a green sub-pixel 412, a blue sub-pixel 413 and a white sub-pixel 414. In an embodiment, the red sub-pixel 411, the green sub-pixel 412, the blue sub-pixel 413 and the white sub-pixel 414 are arranged in a 1×4 matrix. In the RGBW pixel 41A, the sequence of the sub-pixels in the 1×4 matrix from left to right is the red sub-pixel 411, the green sub-pixel 412, the blue sub-pixel 413 and the white sub-pixel 414. In the RGBW pixel 41B, the sequence of the sub-pixels in the 1×4 matrix from left to right is the blue sub-pixel 413, the white sub-pixel 414, the red sub-pixel 411 and the green sub-pixel 412. Each sub-pixel is formed as about a rectangular shape. Any three adjacent sub-pixels along a longer border are formed as about a square shape. That is, three adjacent sub-pixels, for example the red sub-pixel 411, the green sub-pixel 412 and the blue sub-pixel 413 in the RGBW pixel 41A, along a longer border are formed as about a square shape. In the RGBW pixel, the blue sub-pixel has an area about the same as that of the other sub-pixels in the same RGBW pixel.

Each RGBY pixel includes a red sub-pixel, a green sub-pixel, a blue sub-pixel and a yellow sub-pixel. The RGBY pixel 42A includes a red sub-pixel 421, a green sub-pixel 422, a blue sub-pixel 423 and a yellow sub-pixel 424, and the RGBY pixel 42B includes a red sub-pixel 421, a green sub-pixel 422, a blue sub-pixel 423 and a yellow sub-pixel 424. In an embodiment, the red sub-pixel 421, the green sub-pixel 422, the blue sub-pixel 423 and the yellow sub-pixel 424 are arranged in a 1×4 matrix. In the RGBY pixel 42A, the sequence of the sub-pixels in the 1×4 matrix from left to right is the red sub-pixel 421, the green sub-pixel 422, the blue sub-pixel 423 and the yellow sub-pixel 424. In the RGBY pixel 42B, the sequence of the sub-pixels in the 1×4 matrix from left to right is the blue sub-pixel 423, the yellow sub-pixel 424, the red sub-pixel 421 and the green sub-pixel 422.

In the RGBY pixel, the blue sub-pixel has an area larger than that of the other sub-pixels in the same RGBY pixel. That is, the area of the blue sub-pixel 423 is larger than that of the red sub-pixel 421, the area of the blue sub-pixel 423 is larger than that of the green sub-pixel 422, and the area of the blue sub-pixel 423 is larger than that of the yellow sub-pixel 424. In the RGBY pixel, the yellow sub-pixel has an area smaller than that of the other sub-pixels in the same RGBY pixel. That is, the area of the yellow sub-pixel 424 is smaller than that of the red sub-pixel 421, the area of the yellow sub-pixel 424 is smaller than that of the green sub-pixel 422, and the area of the yellow sub-pixel 424 is larger than that of the blue sub-pixel 423. In an embodiment, the yellow sub-pixel 424 has an area about half of that of the blue sub-pixels 423 in the same RGBY pixel. In an embodiment, the yellow sub-pixel has an area about one-third of that of the blue sub-pixels in the same RGBY pixel.

In the image device 20C, the ratio of the number of RGBW pixels to the number of RGBY pixels is about 1:1. In the image device 20C, the blue sub-pixel has a larger area than the other sub-pixels in each RGBY pixel. Therefore a white balance status can be achieved within one RGBY pixel and thus the chrominance quality of the display can be improved.

Referring to FIG. 1D, it shows an image device according to an embodiment of the invention. The image device 20D includes a plurality of RGBW pixels 51A, 51B and a plurality of RGBY pixels 52A, 52B. The RGBW pixels 51A, 51B and the RGBY pixels 52A, 52B are mixed in the image device 20D. Each RGBW pixel includes a red sub-pixel, a green sub-pixel, a blue sub-pixel and a white sub-pixel. The RGBW pixel 51A includes a red sub-pixel 511, a green sub-pixel 512, a blue sub-pixel 513 and a white sub-pixel 514, and the RGBW pixel 51B includes a red sub-pixel 511, a green sub-pixel 512, a blue sub-pixel 513 and a white sub-pixel 514. In an embodiment, the red sub-pixel 511, the green sub-pixel 512, the blue sub-pixel 513 and the white sub-pixel 514 are arranged in a 1×4 matrix. In the RGBW pixel 51A, the sequence of the sub-pixels in the 1×4 matrix from left to right is the red sub-pixel 511, the green sub-pixel 512, the blue sub-pixel 513 and the white sub-pixel 514. In the RGBW pixel 51B, the sequence of the sub-pixels in the 1×4 matrix from left to right is the blue sub-pixel 513, the white sub-pixel 514, the red sub-pixel 511 and the green sub-pixel 512. Each sub-pixel is formed as about a rectangular shape. Any four adjacent sub-pixels along a longer border are formed as about a square shape. That is, four adjacent sub-pixels, for example the red sub-pixel 511, the green sub-pixel 512, the blue sub-pixel 513 and the white sub-pixel 514 in the RGBW pixel 51A, along a longer border are formed as about a square shape. In the RGBW pixel, the blue sub-pixel has an area about the same as that of the other sub-pixels in the same RGBW pixel.

Each RGBY pixel includes a red sub-pixel, a green sub-pixel, a blue sub-pixel and a yellow sub-pixel. The RGBY pixel 52A includes a red sub-pixel 521, a green sub-pixel 522, a blue sub-pixel 523 and a yellow sub-pixel 524, and the RGBY pixel 52B includes a red sub-pixel 521, a green sub-pixel 522, a blue sub-pixel 523 and a yellow sub-pixel 524. In an embodiment, the red sub-pixel 521, the green sub-pixel 522, the blue sub-pixel 523 and the yellow sub-pixel 524 are arranged in a 1×4 matrix. In the RGBY pixel 52A, the sequence of the sub-pixels in the 1×4 matrix from left to right is the red sub-pixel 521, the green sub-pixel 522, the blue sub-pixel 523 and the yellow sub-pixel 524. In the RGBY pixel 52B, the sequence of the sub-pixels in the 1×4 matrix from left to right is the blue sub-pixel 523, the yellow sub-pixel 524, the red sub-pixel 521 and the green sub-pixel 522.

In the RGBY pixel, the blue sub-pixel has an area larger than that of the other sub-pixels in the same RGBY pixel. That is, the area of the blue sub-pixel 523 is larger than that of the red sub-pixel 521, the area of the blue sub-pixel 523 is larger than that of the green sub-pixel 522, and the area of the blue sub-pixel 523 is larger than that of the yellow sub-pixel 524. In the RGBY pixel, the yellow sub-pixel has an area smaller than that of the other sub-pixels in the same RGBY pixel. That is, the area of the yellow sub-pixel 524 is smaller than that of the red sub-pixel 521, the area of the yellow sub-pixel 524 is smaller than that of the green sub-pixel 522, and the area of the yellow sub-pixel 524 is larger than that of the blue sub-pixel 523. In an embodiment, the yellow sub-pixel 524 has an area about half of that of the blue sub-pixels 523 in the same RGBY pixel. In an embodiment, the yellow sub-pixel has an area about one-third of that of the blue sub-pixels in the same RGBY pixel.

In the image device 20D, the ratio of the number of RGBW pixels to the number of RGBY pixels is about 1:1. In the image device 20D, the blue sub-pixel has a larger area than the other sub-pixels in each RGBY pixel. Therefore a white balance status can be achieved within one RGBY pixel and thus the chrominance quality of the display can be improved.

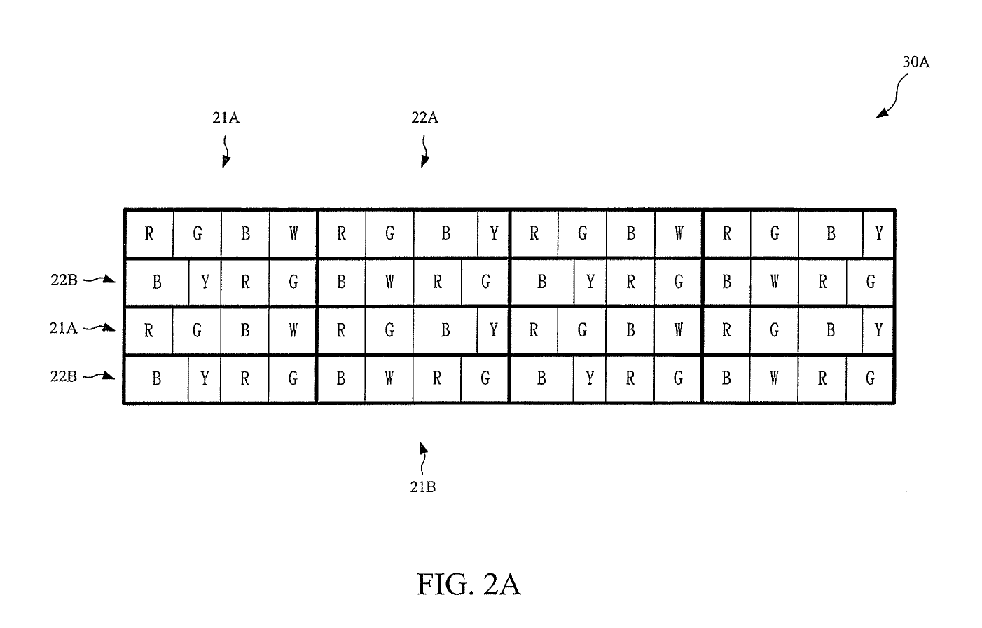

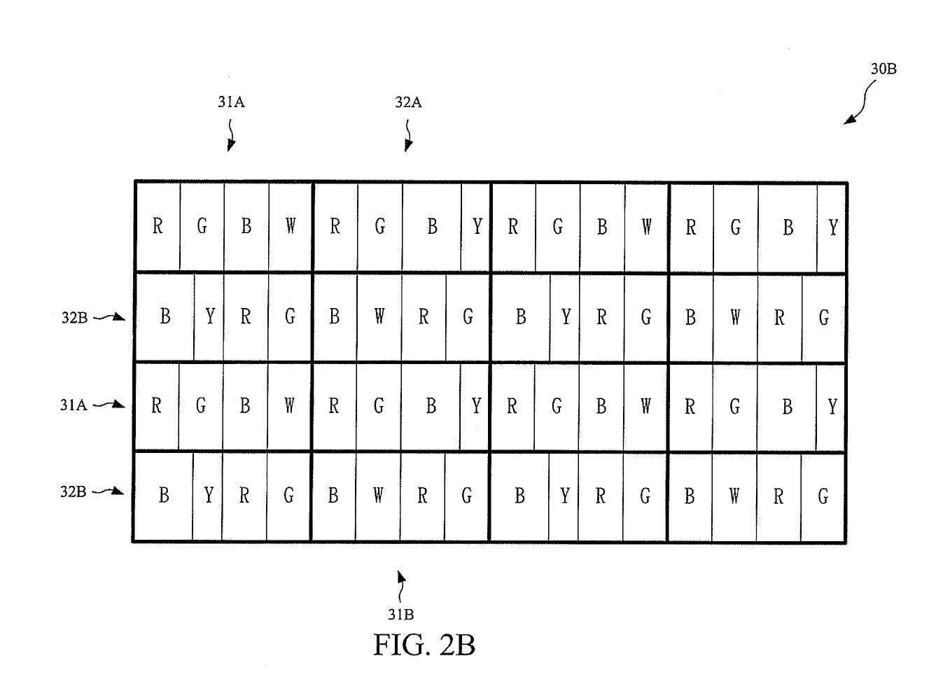

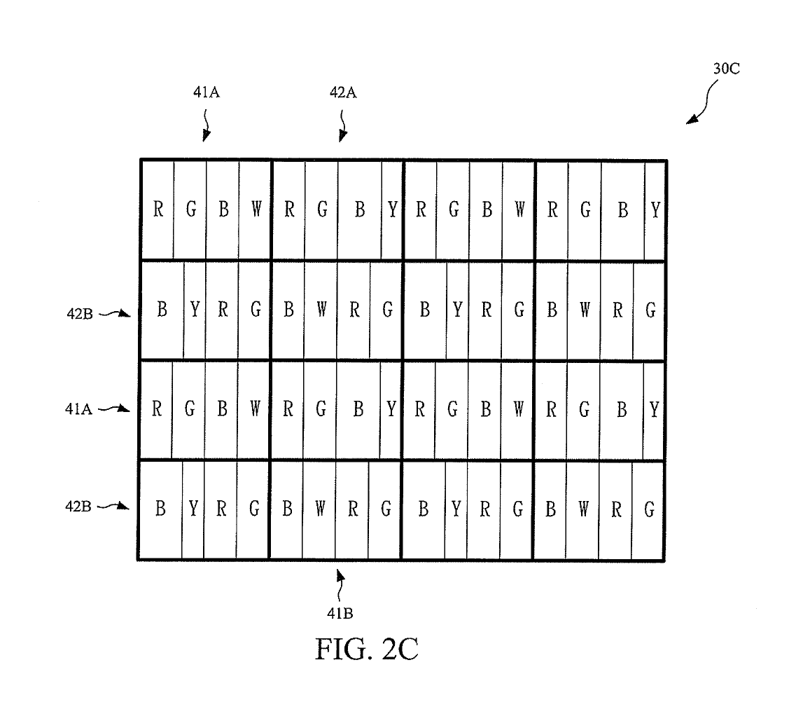

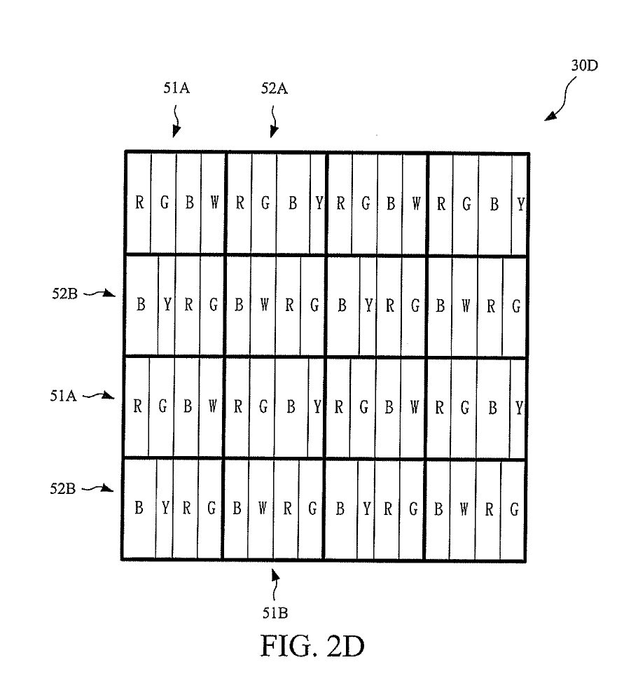

Referring to FIG. 2A, it shows an image device according to an embodiment of the invention. The image device 30A includes a plurality of RGBW pixels 21A, 21B and a plurality of RGBY pixels 22A, 22B. In the image device 30A, the RGBW pixel 21A and the RGBY pixel 22B are alternately arranged on a first column, and the RGBY pixel 22A and the RGBW pixel 21B are alternately arranged on a second column. The RGBW pixel 21A and the RGBY pixel 22A are alternately arranged on a first row, and the RGBY pixel 22B and the RGBW pixel 21B are alternately arranged on a second row.

Referring to FIG. 2B, it shows an image device according to an embodiment of the invention. The image device 30B includes a plurality of RGBW pixels 31A, 31B and a plurality of RGBY pixels 32A, 32B. In the image device 30B, the RGBW pixel 31A and the RGBY pixel 32B are alternately arranged on a first column, and the RGBY pixel 32A and the RGBW pixel 31B are alternately arranged on a second column. The RGBW pixel 31A and the RGBY pixel 32A are alternately arranged on a first row, and the RGBY pixel 32B and the RGBW pixel 31B are alternately arranged on a second row.

Referring to FIG. 2C, it shows an image device according to an embodiment of the invention. The image device 30C includes a plurality of RGBW pixels 41A, 41B and a plurality of RGBY pixels 42A, 42B. In the image device 30C, the RGBW pixel 41A and the RGBY pixel 42B are alternately arranged on a first column, and the RGBY pixel 42A and the RGBW pixel 41B are alternately arranged on a second column. The RGBW pixel 41A and the RGBY pixel 42A are alternately arranged on a first row, and the RGBY pixel 42B and the RGBW pixel 41B are alternately arranged on a second row.

Referring to FIG. 2D, it shows an image device according to an embodiment of the invention. The image device 30D includes a plurality of RGBW pixels 51A, 51B and a plurality of RGBY pixels 52A, 52B. In the image device 30D, the RGBW pixel 51A and the RGBY pixel 52B are alternately arranged on a first column, and the RGBY pixel 52A and the RGBW pixel 51B are alternately arranged on a second column. The RGBW pixel 51A and the RGBY pixel 52A are alternately arranged on a first row, and the RGBY pixel 52B and the RGBW pixel 51B are alternately arranged on a second row.

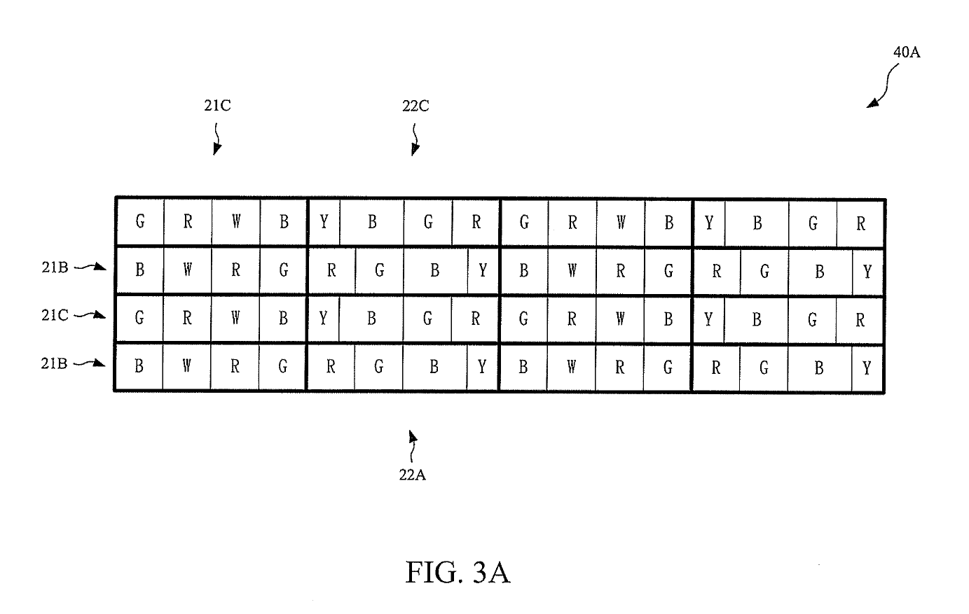

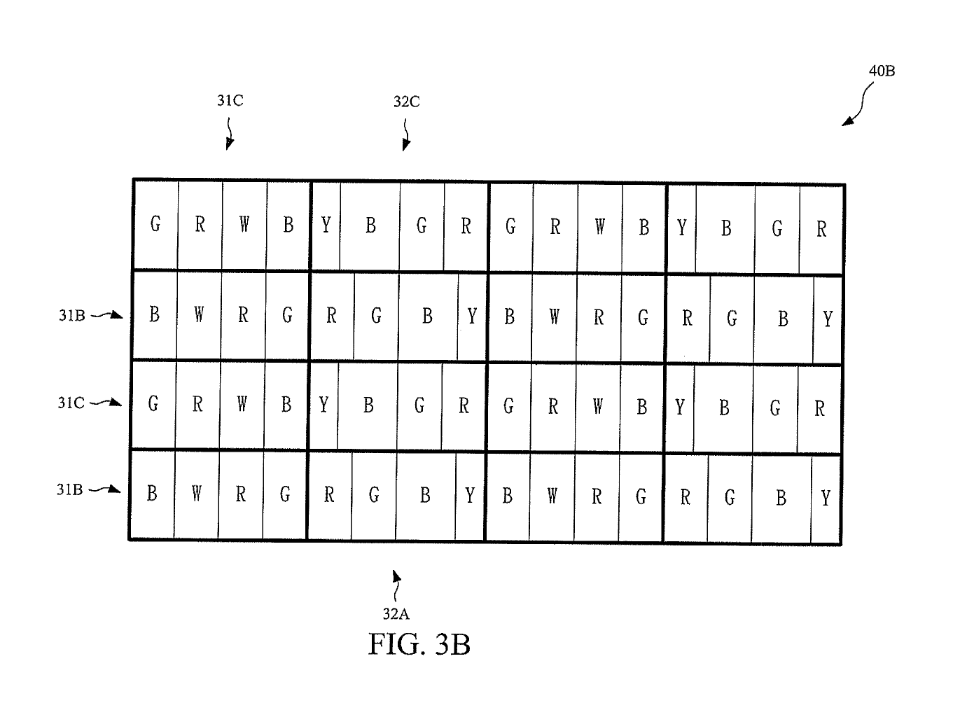

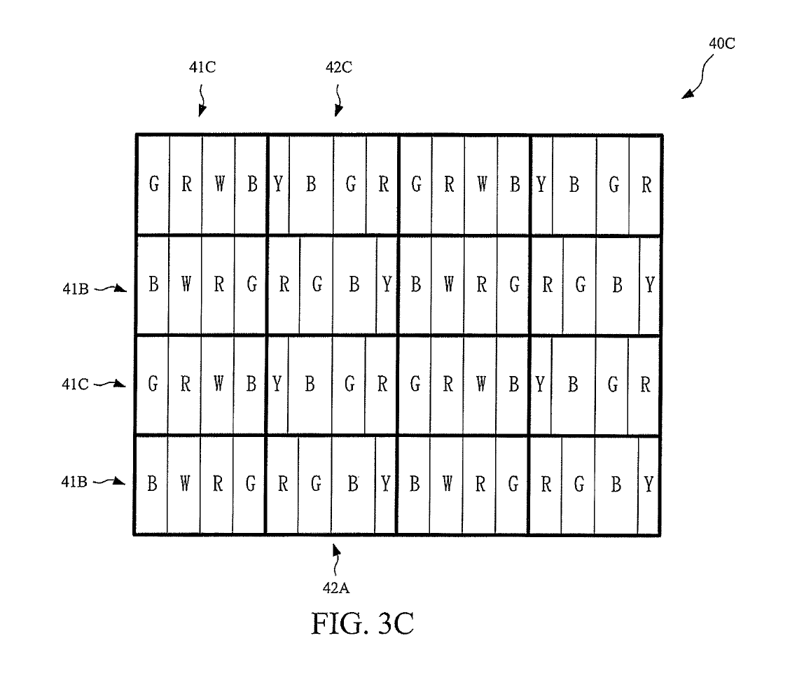

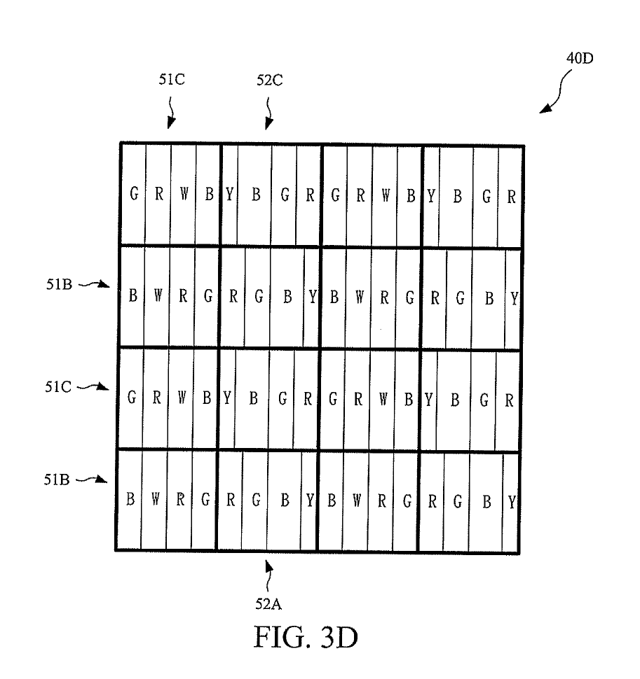

Referring to FIG. 3A, it shows an image device according to an embodiment of the invention. The image device 40A includes a plurality of RGBW pixels 21B, 21C and a plurality of RGBY pixels 22A, 22C. In the RGBW pixel 21C, the sequence of the sub-pixels in the 1×4 matrix from left to right is the green sub-pixel, the red sub-pixel, the white sub-pixel and the blue sub-pixel. In the RGBY pixel 22C, the sequence of the sub-pixels in the 1×4 matrix from left to right is the yellow sub-pixel, the blue sub-pixel, the green sub-pixel and the red sub-pixel. In the image device 40A, the RGBW pixel 21C and the RGBW pixel 21B are alternately arranged on a first column, and the RGBY pixel 22C and the RGBY pixel 22A are alternately arranged on a second column. The RGBW pixel 21C and the RGBY pixel 22C are alternately arranged on a first row, and the RGBW pixel 21B and the RGBY pixel 22A are alternately arranged on a second row.

In an embodiment, any four adjacent sub-pixels arranged in a 2×2 matrix can produce a white color. In the image device 40A, in any four adjacent sub-pixels arranged in a 2×2 matrix the two sub-pixels having higher light intensities than the other two sub-pixels in a white balance status are disposed on diagonal positions of the 2×2 matrix. For example, the green sub-pixel and the red sub-pixel in the RGBW pixel 21C and the blue sub-pixel and the white sub-pixel in the RGBW pixel 21B are arranged in a 2×2 matrix, and the green sub-pixel and the white sub-pixel having higher light intensities than the red sub-pixel and the blue sub-pixel in a white balance status are disposed on diagonal positions of the 2×2 matrix. It has the further advantages of eliminating color fringe problem. For example alternating back and white lines can be displayed without color fringe. Another example is that fonts can be displayed without color fringe.

Referring to FIG. 3B, it shows an image device according to an embodiment of the invention. The image device 40B includes a plurality of RGBW pixels 31B, 31C and a plurality of RGBY pixels 32A, 32C. In the RGBW pixel 31C, the sequence of the sub-pixels in the 1×4 matrix from left to right is the green sub-pixel, the red sub-pixel, the white sub-pixel and the blue sub-pixel. In the RGBY pixel 32C, the sequence of the sub-pixels in the 1×4 matrix from left to right is the yellow sub-pixel, the blue sub-pixel, the green sub-pixel and the red sub-pixel. In the image device 40B, the RGBW pixel 31C and the RGBW pixel 31B are alternately arranged on a first column, and the RGBY pixel 32C and the RGBY pixel 32A are alternately arranged on a second column. The RGBW pixel 31C and the RGBY pixel 32C are alternately arranged on a first row, and the RGBW pixel 31B and the RGBY pixel 32A are alternately arranged on a second row.

In an embodiment, any four adjacent sub-pixels arranged in a 2×2 matrix can produce a white color. In the image device 40B, in any four adjacent sub-pixels arranged in a 2×2 matrix the two sub-pixels having higher light intensities than the other two sub-pixels in a white balance status are disposed on diagonal positions of the 2×2 matrix. For example, the green sub-pixel and the red sub-pixel in the RGBW pixel 31C and the blue sub-pixel and the white sub-pixel in the RGBW pixel 31B are arranged in a 2×2 matrix, and the green sub-pixel and the white sub-pixel having higher light intensities than the red sub-pixel and the blue sub-pixel in a white balance status are disposed on diagonal positions of the 2×2 matrix. It has the further advantages of eliminating color fringe problem. For example alternating back and white lines can be displayed without color fringe. Another example is that fonts can be displayed without color fringe.

Referring to FIG. 3C, it shows an image device according to an embodiment of the invention. The image device 40C includes a plurality of RGBW pixels 41B, 41C and a plurality of RGBY pixels 42A, 42C. In the RGBW pixel 41C, the sequence of the sub-pixels in the 1×4 matrix from left to right is the green sub-pixel, the red sub-pixel, the white sub-pixel and the blue sub-pixel. In the RGBY pixel 42C, the sequence of the sub-pixels in the 1×4 matrix from left to right is the yellow sub-pixel, the blue sub-pixel, the green sub-pixel and the red sub-pixel. In the image device 40C, the RGBW pixel 41C and the RGBW pixel 41B are alternately arranged on a first column, and the RGBY pixel 42C and the RGBY pixel 42A are alternately arranged on a second column. The RGBW pixel 41C and the RGBY pixel 42C are alternately arranged on a first row, and the RGBW pixel 41B and the RGBY pixel 42A are alternately arranged on a second row.

In an embodiment, any four adjacent sub-pixels arranged in a 2×2 matrix can produce a white color. In the image device 40A, in any four adjacent sub-pixels arranged in a 2×2 matrix the two sub-pixels having higher light intensities than the other two sub-pixels in a white balance status are disposed on diagonal positions of the 2×2 matrix. For example, the green sub-pixel and the red sub-pixel in the RGBW pixel 41C and the blue sub-pixel and the white sub-pixel in the RGBW pixel 41B are arranged in a 2×2 matrix, and the green sub-pixel and the white sub-pixel having higher light intensities than the red sub-pixel and the blue sub-pixel in a white balance status are disposed on diagonal positions of the 2×2 matrix. It has the further advantages of eliminating color fringe problem. For example alternating back and white lines can be displayed without color fringe. Another example is that fonts can be displayed without color fringe.

Referring to FIG. 3D, it shows an image device according to an embodiment of the invention. The image device 40D includes a plurality of RGBW pixels 51B, 51C and a plurality of RGBY pixels 52A, 52C. In the RGBW pixel 51C, the sequence of the sub-pixels in the 1×4 matrix from left to right is the green sub-pixel, the red sub-pixel, the white sub-pixel and the blue sub-pixel. In the RGBY pixel 52C, the sequence of the sub-pixels in the 1×4 matrix from left to right is the yellow sub-pixel, the blue sub-pixel, the green sub-pixel and the red sub-pixel. In the image device 40D, the RGBW pixel 51C and the RGBW pixel 51B are alternately arranged on a first column, and the RGBY pixel 52C and the RGBY pixel 52A are alternately arranged on a second column. The RGBW pixel 51C and the RGBY pixel 52C are alternately arranged on a first row, and the RGBW pixel 51B and the RGBY pixel 52A are alternately arranged on a second row.

In an embodiment, any four adjacent sub-pixels arranged in a 2×2 matrix can produce a white color. In the image device 40D, in any four adjacent sub-pixels arranged in a 2×2 matrix the two sub-pixels having higher light intensities than the other two sub-pixels in a white balance status are disposed on diagonal positions of the 2×2 matrix. For example, the green sub-pixel and the red sub-pixel in the RGBW pixel 51C and the blue sub-pixel and the white sub-pixel in the RGBW pixel 51B are arranged in a 2×2 matrix, and the green sub-pixel and the white sub-pixel having higher light intensities than the red sub-pixel and the blue sub-pixel in a white balance status are disposed on diagonal positions of the 2×2 matrix. It has the further advantages of eliminating color fringe problem. For example alternating back and white lines can be displayed without color fringe. Another example is that fonts can be displayed without color fringe.

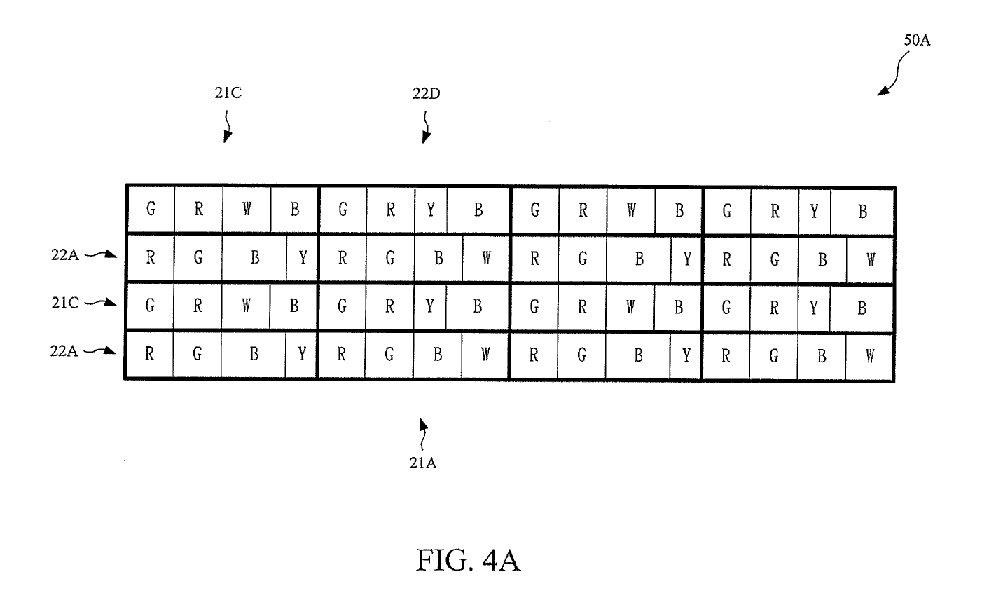

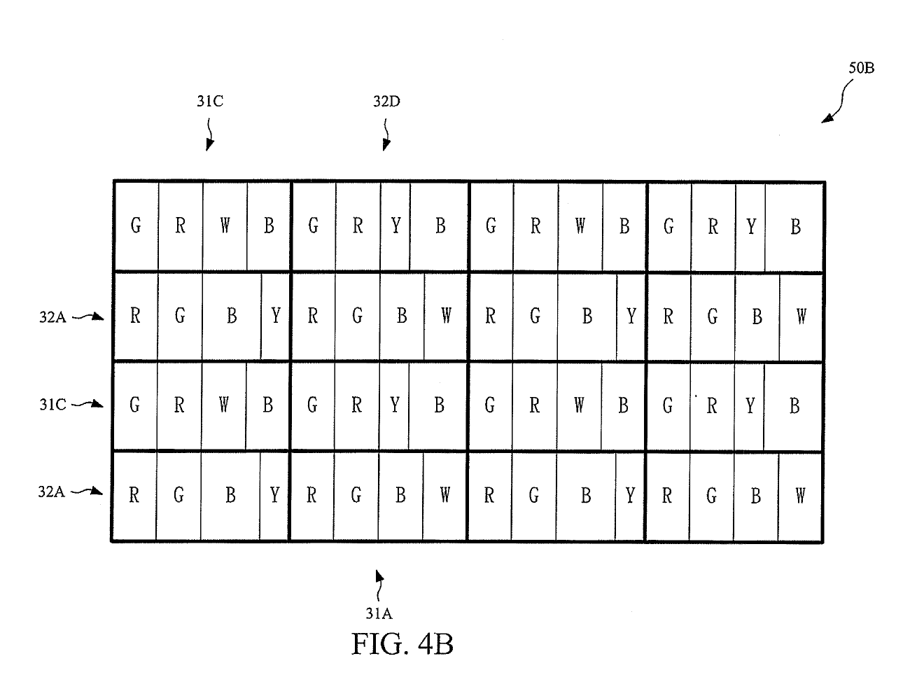

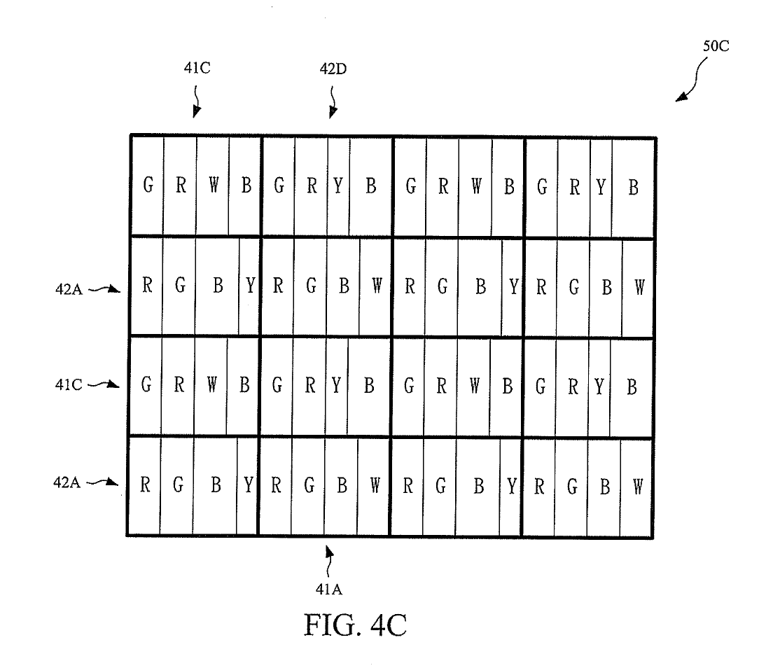

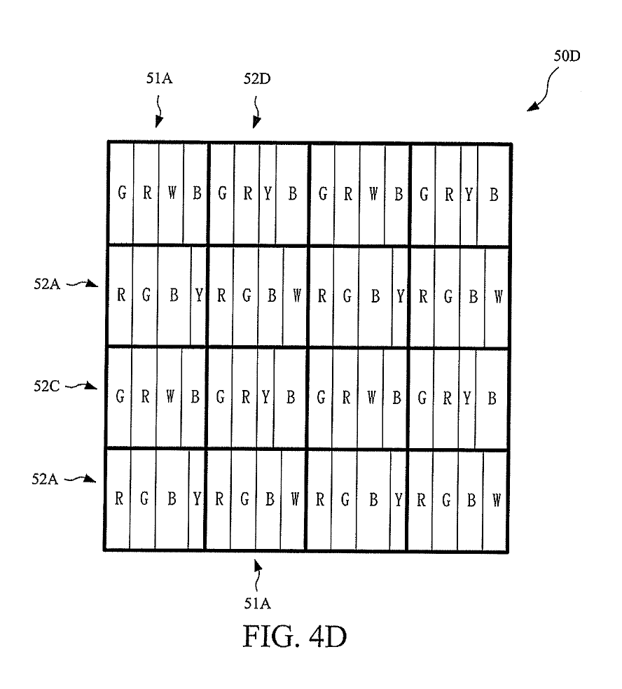

Referring to FIG. 4A, it shows an image device according to an embodiment of the invention. The image device 50A includes a plurality of RGBW pixels 21A, 21C and a plurality of RGBY pixels 22A, 22D. In the RGBY pixel 22D, the sequence of the sub-pixels in the 1×4 matrix from left to right is the green sub-pixel, the red sub-pixel, the yellow sub-pixel and the blue sub-pixel. In the image device 50A, the RGBW pixel 21C and the RGBY pixel 22A are alternately arranged on a first column, and the RGBY pixel 22D and the RGBW pixel 21A are alternately arranged on a second column. The RGBW pixel 21C and the RGBY pixel 22D are alternately arranged on a first row, and the RGBY pixel 22A and the RGBW pixel 21A are alternately arranged on a second row.

In an embodiment, any four adjacent sub-pixels arranged in a 2×2 matrix can produce a white color. In the image device 50A, in any four adjacent sub-pixels arranged in a 2×2 matrix the two sub-pixels having higher light intensities than the other two sub-pixels in a white balance status are disposed on diagonal positions of the 2×2 matrix. For example, the red sub-pixel and the white sub-pixel in the RGBW pixel 21C and the green sub-pixel and the blue sub-pixel in the RGBY pixel 22A are arranged in a 2×2 matrix, and the green sub-pixel and the white sub-pixel having higher light intensities than the red sub-pixel and the blue sub-pixel in a white balance status are disposed on diagonal positions of the 2×2 matrix. It has the further advantages of eliminating color fringe problem. For example alternating back and white lines can be displayed without color fringe. Another example is that fonts can be displayed without color fringe.

Referring to FIG. 4B, it shows an image device according to an embodiment of the invention. The image device 50B includes a plurality of RGBW pixels 31A, 31C and a plurality of RGBY pixels 32A, 32D. In the RGBY pixel 32D, the sequence of the sub-pixels in the 1×4 matrix from left to right is the green sub-pixel, the red sub-pixel, the yellow sub-pixel and the blue sub-pixel. In the image device 50B, the RGBW pixel 31C and the RGBY pixel 32A are alternately arranged on a first column, and the RGBY pixel 32D and the RGBW pixel 31A are alternately arranged on a second column. The RGBW pixel 31C and the RGBY pixel 32D are alternately arranged on a first row, and the RGBY pixel 32A and the RGBW pixel 31A are alternately arranged on a second row.

In an embodiment, any four adjacent sub-pixels arranged in a 2×2 matrix can produce a white color. In the image device 50B, in any four adjacent sub-pixels arranged in a 2×2 matrix the two sub-pixels having higher light intensities than the other two sub-pixels in a white balance status are disposed on diagonal positions of the 2×2 matrix. For example, the red sub-pixel and the white sub-pixel in the RGBW pixel 31C and the green sub-pixel and the blue sub-pixel in the RGBY pixel 32A are arranged in a 2×2 matrix, and the green sub-pixel and the white sub-pixel having higher light intensities than the red sub-pixel and the blue sub-pixel in a white balance status are disposed on diagonal positions of the 2×2 matrix. It has the further advantages of eliminating color fringe problem. For example alternating back and white lines can be displayed without color fringe. Another example is that fonts can be displayed without color fringe.

Referring to FIG. 4C, it shows an image device according to an embodiment of the invention. The image device 50C includes a plurality of RGBW pixels 41A, 41C and a plurality of RGBY pixels 42A, 42D. In the RGBY pixel 42D, the sequence of the sub-pixels in the 1×4 matrix from left to right is the green sub-pixel, the red sub-pixel, the yellow sub-pixel and the blue sub-pixel. In the image device 50C, the RGBW pixel 41C and the RGBY pixel 42A are alternately arranged on a first column, and the RGBY pixel 42D and the RGBW pixel 41A are alternately arranged on a second column. The RGBW pixel 41C and the RGBY pixel 42D are alternately arranged on a first row, and the RGBY pixel 42A and the RGBW pixel 41A are alternately arranged on a second row.

In an embodiment, any four adjacent sub-pixels arranged in a 2×2 matrix can produce a white color. In the image device 50C, in any four adjacent sub-pixels arranged in a 2×2 matrix the two sub-pixels having higher light intensities than the other two sub-pixels in a white balance status are disposed on diagonal positions of the 2×2 matrix. For example, the red sub-pixel and the white sub-pixel in the RGBW pixel 41C and the green sub-pixel and the blue sub-pixel in the RGBY pixel 42A are arranged in a 2×2 matrix, and the green sub-pixel and the white sub-pixel having higher light intensities than the red sub-pixel and the blue sub-pixel in a white balance status are disposed on diagonal positions of the 2×2 matrix. It has the further advantages of eliminating color fringe problem. For example alternating back and white lines can be displayed without color fringe. Another example is that fonts can be displayed without color fringe.

Referring to FIG. 4D, it shows an image device according to an embodiment of the invention. The image device 50D includes a plurality of RGBW pixels 51A, 51C and a plurality of RGBY pixels 52A, 52D. In the RGBY pixel 52D, the sequence of the sub-pixels in the 1×4 matrix from left to right is the green sub-pixel, the red sub-pixel, the yellow sub-pixel and the blue sub-pixel. In the image device 50D, the RGBW pixel 51C and the RGBY pixel 52A are alternately arranged on a first column, and the RGBY pixel 52D and the RGBW pixel 51A are alternately arranged on a second column. The RGBW pixel 51C and the RGBY pixel 52D are alternately arranged on a first row, and the RGBY pixel 52A and the RGBW pixel 51A are alternately arranged on a second row.

In an embodiment, any four adjacent sub-pixels arranged in a 2×2 matrix can produce a white color. In the image device 50D, in any four adjacent sub-pixels arranged in a 2×2 matrix the two sub-pixels having higher light intensities than the other two sub-pixels in a white balance status are disposed on diagonal positions of the 2×2 matrix. For example, the red sub-pixel and the white sub-pixel in the RGBW pixel 51C and the green sub-pixel and the blue sub-pixel in the RGBY pixel 52A are arranged in a 2×2 matrix, and the green sub-pixel and the white sub-pixel having higher light intensities than the red sub-pixel and the blue sub-pixel in a white balance status are disposed on diagonal positions of the 2×2 matrix. It has the further advantages of eliminating color fringe problem. For example alternating back and white lines can be displayed without color fringe. Another example is that fonts can be displayed without color fringe.

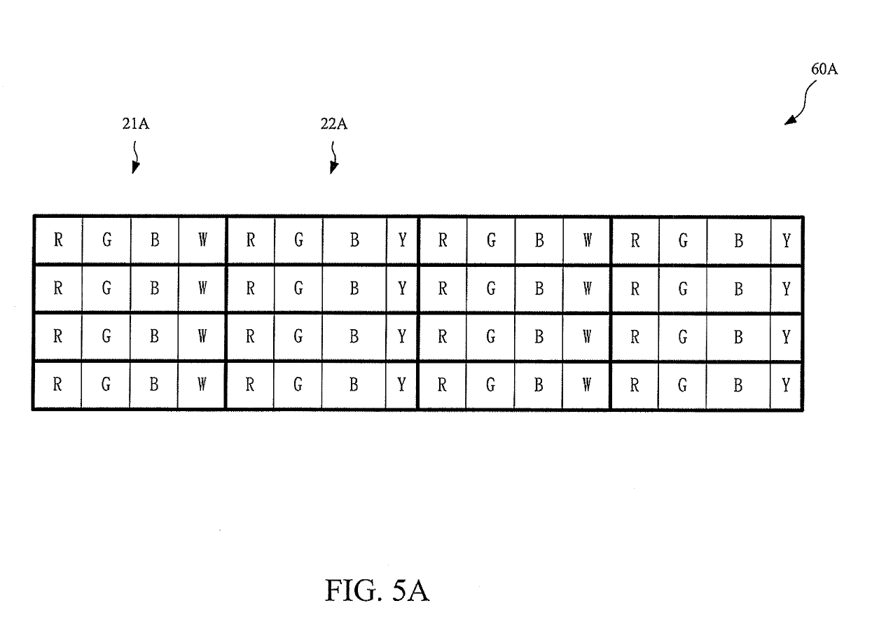

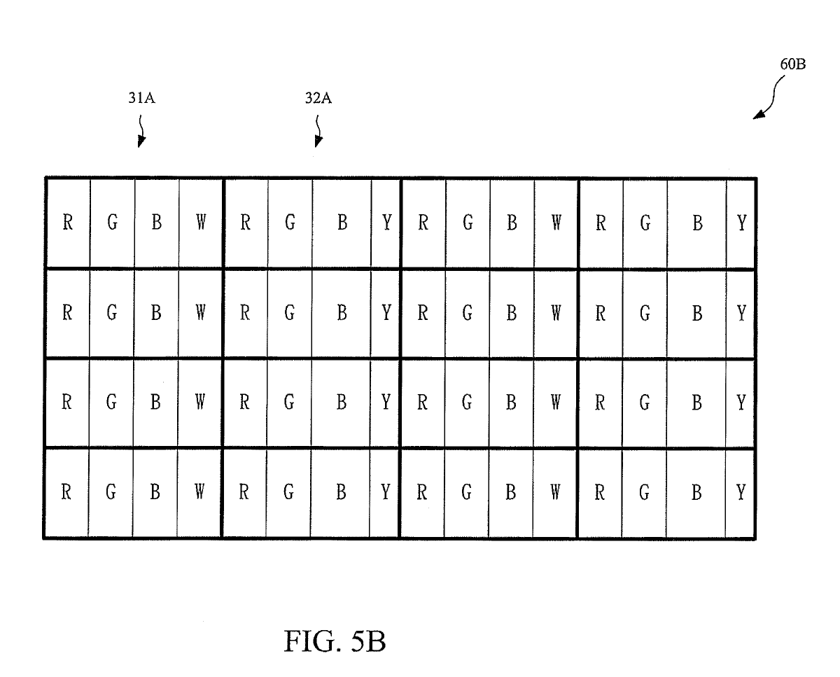

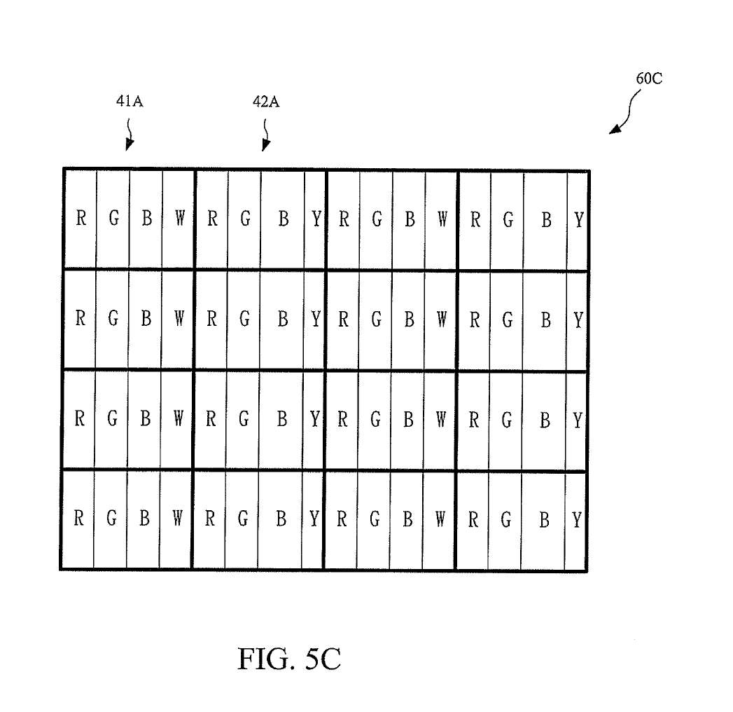

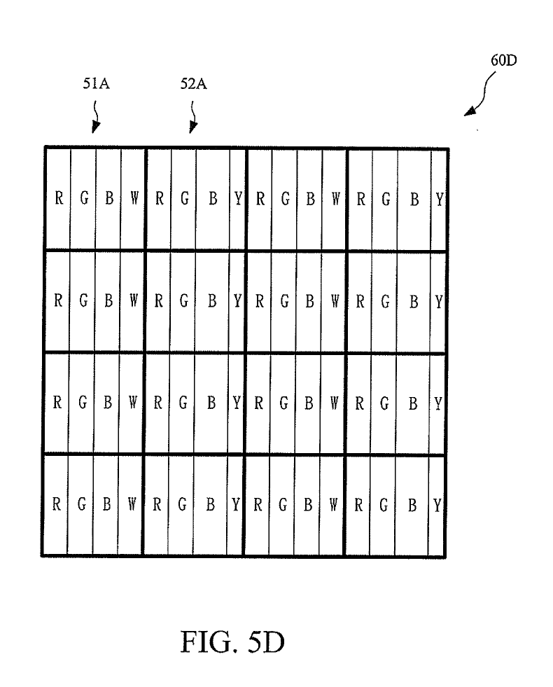

Referring to FIG. 5A, it shows an image device according to an embodiment of the invention. The image device 60A includes a plurality of RGBW pixels 21A and a plurality of RGBY pixels 22A. In an embodiment, all sub-pixels in at least one row or in at least one column have the same color. In the image device 60A, all sub-pixels in at least one column have the same color.

Referring to FIG. 5B, it shows an image device according to an embodiment of the invention. The image device 60B includes a plurality of RGBW pixels 31A and a plurality of RGBY pixels 32A. In an embodiment, all sub-pixels in at least one row or in at least one column have the same color. In the image device 60B, all sub-pixels in at least one column have the same color.

Referring to FIG. 5C, it shows an image device according to an embodiment of the invention. The image device 60C includes a plurality of RGBW pixels 41A and a plurality of RGBY pixels 42A. In an embodiment, all sub-pixels in at least one row or in at least one column have the same color. In the image device 60C, all sub-pixels in at least one column have the same color.

Referring to FIG. 5D, it shows an image device according to an embodiment of the invention. The image device 60D includes a plurality of RGBW pixels 51A and a plurality of RGBY pixels 52A. In an embodiment, all sub-pixels in at least one row or in at least one column have the same color. In the image device 60D, all sub-pixels in at least one column have the same color.

The ratio of the number of RGBW pixels to the number of RGBY pixels may be about 1:1, 2:1, 3:1, 3:2, 4:1, 4:3, 5:1, 5:2, 5:3, 5:4, 6:1, 6:5, 7:1, 7:2, 7:3, 7:4, 7:5, 7:6, 8:1, 8:3, 8:5, 8:7, 9:1, 9:2, 9:4, 9:5, 9:7 or 9:8.

Further, a designated white balance status can be maintained by adjusting the blue information of the image device. In case of liquid-crystal display LCD, for example the backlight color can be adjusted, and/or the thickness, area, and/or pigment of the blue sub-pixels in the color filter can be adjusted, and/or the utilization of quantum dots can be adjusted so as to adjust the blue information and to maintain a designated white balance status of the image device. In case of organic light-emitting diode OLED plus color filter, OLED color can be adjusted to bluish, and/or the thickness, area, and/or pigment of the blue sub-pixels in the color filter can be adjusted, and/or the utilization of quantum dots can be adjusted so as to adjust the blue information and to maintain a designated white balance status of the image device.

The invention provides a method to determine the ratio of the number of RGBW pixels to the number of RGBY pixels in an image device according to the invention. The method of the invention includes a step for determining the ratio by a function of a yellow sub-pixel information, a red sub-pixel information, a green sub-pixel information, a blue sub-pixel information and a white sub-pixel information of the image device. The sub-pixel information includes the chrominance data and luminance data of the said sub-pixel. In an embodiment, the yellow sub-pixel information includes the chrominance data and luminance data of the yellow sub-pixel, the red sub-pixel information includes the chrominance data and luminance data of the red sub-pixel, the green sub-pixel information includes the chrominance data and luminance data of the green sub-pixel, and the white sub-pixel information includes the chrominance data and luminance data of the white sub-pixel.

The invention further provides a method to determine the ratio of the number of RGBW pixels to the number of RGBY pixels in an image device according to the invention. The method of the invention includes a step for determining the ratio by a function of a yellow sub-pixel information and a white sub-pixel information of the image device. The sub-pixel information includes the chrominance data and luminance data of the said sub-pixel. In an embodiment, the yellow sub-pixel information includes the chrominance data and luminance data of the yellow sub-pixel, and the white sub-pixel information includes the chrominance data and luminance data of the white sub-pixel.

In the present invention, the blue sub-pixel has a larger area than the other sub-pixels in each RGBY pixel. Therefore a white balance status can be achieved within one RGBY pixel and thus the chrominance quality of the display can be improved. In some of the embodiments of the present invention, any four adjacent sub-pixel arranged in a 2×2 matrix can produce a white color. These embodiments have the further advantages of eliminating color fringe problem. For example alternating back and white lines can be displayed without color fringe. Another example is that fonts can be displayed without color fringe.

While embodiments of the present invention have been illustrated and described, various modifications and improvements can be made by persons skilled in the art. It is intended that the present invention is not limited to the particular forms as illustrated, and that all modifications not departing from the spirit and scope of the present invention are within the scope as defined in the following claims.

What is claimed is:

1. An image device, comprising:
a plurality of RGBW pixels, each of the RGBW pixels comprising a red sub-pixel, a green sub-pixel, a blue sub-pixel and a white sub-pixel; and
a plurality of the RGBY pixels, each of the RGBY pixels comprising a red sub-pixel, a green sub-pixel, a blue sub-pixel and a yellow sub-pixel;
wherein in each of the RGBW pixels, the blue sub-pixel has an area about the same as that of the other sub-pixels in the same RGBW pixel, and
in each of the RGBY pixels the blue sub-pixel has an area larger than that of the other sub-pixels in the same RGBY pixel, and
the RGBW pixels and the RGBY pixels are mixed in the image device.

2. The image device according to claim 1, wherein in each of the RGBY pixels, the yellow sub-pixel has an area smaller than that of the other sub-pixels in the same RGBY pixel.

3. The image device according to claim 2, wherein in each of the RGBY pixels the yellow sub-pixel has an area about half of that of the blue sub-pixels in the same RGBY pixel.

4. The image device according to claim 2, wherein in each of the RGBY pixels the yellow sub-pixel has an area about one-third of that of the blue sub-pixels in the same RGBY pixel.

5. The image device according to claim 1, wherein a ratio of a number of RGBW pixels to a number of RGBY pixels is about 1:1.

6. The image device according to claim 1, wherein a ratio of a number of RGBW pixels to a number of RGBY pixels is about 2:1.

7. The image device according to claim 1, wherein a ratio of a number of RGBW pixels to a number of RGBY pixels is about 3:1.

8. The image device according to claim 1, wherein any four adjacent ones of the sub-pixels arranged in a 2×2 matrix can produce a white color.

9. The image device according to claim 1, wherein in any four adjacent ones of the sub-pixels arranged in a 2×2 matrix, two of the sub-pixels having higher light intensities than the other two of the sub-pixels in a white balance status are disposed on diagonal positions of the 2×2 matrix.

10. The image device according to claim 1, wherein all of the sub-pixels in at least one row or in at least one column have the same color.

11. The image device according to claim 1, wherein each of the sub-pixels is formed as about a square shape.

12. The image device according to claim 1, wherein each of the sub-pixels is formed as about a rectangular shape.

13. The image device according to claim 12, wherein any two of the sub-pixels adjacent to each other along a longer border are formed as about a square shape.

14. The image device according to claim 12, wherein any three of the sub-pixels adjacent to each other along a longer border are formed as about a square shape.

15. The image device according to claim 12, wherein any four of the sub-pixels adjacent to each other along a longer border are formed as about a square shape.

16. The image device according to claim 1, wherein a designated white balance status is maintained.

17. The image device according to claim 16, wherein the designated white balance status of the image device is maintained by adjusting blue information of the image device.

18. The image device according to claim 17, wherein the image device is a LCD image device.

19. The image device according to claim 18, wherein the blue information of the image device is adjusted by adjusting a backlight color, and/or adjusting a thickness, an area, and/or a pigment of the blue sub-pixels in a color filter, and/or utilization of quantum dots.

20. The image device according to claim 17, wherein the image device is an OLED plus color filter image device.

21. The image device according to claim 20, wherein the blue information of the image device is adjusted by adjusting OLED color to bluish, and/or a thickness, an area, and/or a pigment of the blue sub-pixels in a color filter, and/or utilization of quantum dots.

22. A method to determine a ratio of a number of RGBW pixels to a number of RGBY pixels in the image device according to claim 1,
the method comprising:
a step for determining the ratio by a function of a yellow sub-pixel information, a red sub-pixel information, a green sub-pixel information, a blue sub-pixel information and a white sub-pixel information of the image device.

23. The method according to claim 22, wherein the sub-pixel information comprises the chrominance and luminance data of the sub-pixels.

24. A method to determine a ratio of a number of RGBW pixels to a number of RGBY pixels in the image device according to claim 1,
the method comprising:
a step for determining the ratio by a function of a yellow sub-pixel information and a white sub-pixel information of the image device.

25. The method according to claim 24, wherein the sub-pixel information comprises the chrominance data and luminance data of the sub-pixels.
